(19) United States
(12) Patent Application Publication
(10) Pub. No.: US 2023/0258787 A1
(43) Pub. Date: Aug. 17, 2023

(54) VALIDATION OF A LIDAR SYSTEM BASED ON AN ILLUMINATION PROFILE

(71) Applicant: GM Cruise Holdings LLC, SAN FRANCISCO, CA (US)

(72) Inventors: Stephanie Hsu, San Mateo, CA (US); Kevin Newman, San Bruno, CA (US); Hui Li, San Jose, CA (US)

(21) Appl. No.: 17/674,058

(22) Filed: Feb. 17, 2022

(51) Int. Cl. G01S 7/497; G01S 7/481; G01S 17/931

(52) U.S. Cl. CPC G01S 7/497; G01S 7/4814; G01S 17/931

(57) ABSTRACT

The subject disclosure relates to techniques for validating a lidar system based on an illumination profile. A process of the disclosed technology can include steps of receiving data associated with a lidar system comprising a laser-based light source, a receiver, and a lens, the lidar system being configured to project laser illumination to scan a field of view, receiving target data representing a target area within the field of view, receiving environmental variables associated with the field of view, determining an amount of light across the field of view based on the data associated with the lidar system, and environmental variables, and generating an illumination profile based on the amount of light. Systems and machine-readable media are also provided.

### TECHNICAL FIELD

The subject matter of this disclosure relates in general to the field of Light Detection and Ranging (LiDAR) sensor units, and more particularly, to systems and methods for validating a lidar system based on an illumination profile.

### BACKGROUND

Autonomous vehicles (AVs) have computers and control systems that perform driving and navigation tasks conventionally performed by a human driver. As AV technologies continue to advance, a real-world simulation for AV testing has been critical in improving the safety and efficiency of AV driving. An exemplary AV can include various sensors, such as a camera sensor, a LiDAR sensor, and a Radio Detection and Ranging (RADAR) sensor, among others.

### BRIEF DESCRIPTION OF THE DRAWINGS

In order to describe the manner in which the above-recited and other advantages and features of the disclosure can be obtained, a more particular description of the principles briefly described above will be rendered by reference to specific embodiments thereof which are illustrated in the appended drawings. Understanding that these drawings depict only exemplary embodiments of the disclosure and are not, therefore, to be considered to be limiting of its scope, the principles herein are described and explained with additional specificity and detail through the use of the accompanying drawings in which:

FIG. 1 illustrates an example of a system for managing one or more Autonomous Vehicles (AVs) in accordance with some aspects of the present technology.

FIGS. 2A and 2B illustrate an example environment for a lidar system according to some aspects of the disclosed technology.

FIGS. 3A and 3B illustrate an example diagram for a lidar validation system according to some aspects of the disclosed technology.

FIG. 4 a flowchart of an example method for validating a lidar system based on art illumination profile, according to some aspects of the disclosed technology.

FIG. 5 shows an example of a computing system for implementing certain aspects of the present technology.

### SUMMARY

Disclosed are systems, apparatuses, methods, computer-readable medium, and circuits for validating a lidar system based on an illumination profile. According to at least one example, a method includes receiving data associated with a lidar system comprising a laser-based light source, a receiver, and a lens, the lidar system being configured to project laser illumination to scan a field of view, receiving target data representing a target area within the field of view, receiving environmental variables associated with the field of view, determining an amount of light across the field of view based on the data associated with the lidar system, and environmental variables, and generating an illumination profile based on the amount of light. In some instances, the laser-based light source is a vertical-cavity surface-emitting laser (VCSEL). Also, the lens can be configured to redirect laser illumination from the laser-based light source.

In some examples, the determination of the amount of light across the field of view includes determining an amount of photons emitted by the laser-based light source to each portion of the field of view and determining an amount of photons received by the receiver of the lidar system for each portion of the field of view.

In some examples, the data associated with the lidar system include at least one of radiant intensity, a diffuser angle, a wavelength of the laser illumination emitted by the laser-based light source, art illumination ratio, or a number of the laser-based light source. In some instances, the illumination ratio is greater than 1.

In some examples, the environmental variables associated with the field of view include at least one of an amount of ambient light, a reflectivity, an atmospheric extinction, or temperature.

In another example, a system for a lidar system validation based on an illumination profile includes storage (e.g., a memory configured to store data, such as virtual content data, one or more images, etc.), and one or more processors (e.g., implemented in circuitry) coupled to the memory and configured to execute instructions and, in conjunction with various components (e.g., a network interface, a display, an output device, etc.), cause the system to receive data associated with a Light Detection and Ranging (lidar) system comprising a laser-based light source, a receiver, and a lens, the lidar system being configured to project laser illumination to scan a field of view, receive target data representing a target area within the field of view, receive environmental variables associated with the field of view, determine an amount of light across the field of view based on the data associated with the lidar system, and environmental variables, and generate art illumination profile based on the amount of light.

A non-transitory computer-readable storage medium having stored therein instructions which, when executed by one or more processors, can cause the one or more processors to receive data associated with a Light Detection and Ranging (lidar) system comprising a laser-based light source, a receiver, and a lens, the lidar system being configured to project laser illumination to scan a field of view, receive target data representing a target area within the field of view, receive environmental variables associated with the field of view, determine an amount of light across the field of view based on the data associated with the lidar system, and environmental variables, and generate art illumination profile based on the amount of light.

### DETAILED DESCRIPTION

Various embodiments of the disclosure are discussed in detail below. While specific implementations are discussed, it should be understood that this is done for illustration purposes only. A person skilled in the relevant art will recognize that other components and configurations may be used without parting from the spirit and scope of the disclosure. Thus, the following description and drawings are illustrative and are not to be construed as limiting. Numerous specific details are described to provide a thorough understanding of the disclosure. However, in certain instances, well-known or conventional details are not described in order to avoid obscuring the description. References to one or art embodiment in the present disclosure can be references to the same embodiment or any embodiment; and, such references mean at least one of the embodiments.

As described herein, one aspect of the present technology is the gathering and use of data available from various sources to improve quality and experience. The present disclosure contemplates that in some instances, this gathered data may include personal information. The present disclosure contemplates that the entities involved with such personal information respect and value privacy policies and practices.

The terms used in this specification generally have their ordinary meanings in the art, within the context of the disclosure, and in the specific context where each term is used. Alternative language and synonyms may be used for any one or more of the terms discussed herein, and no special significance should be placed upon whether or not a term is elaborated or discussed herein. In some cases, synonyms for certain terms are provided. A recital of one or more synonyms does not exclude the use of other synonyms. The use of examples anywhere in this specification including examples of any terms discussed herein is illustrative only and is not intended to further limit the scope and meaning of the disclosure or any example term. Likewise, the disclosure is not limited to various embodiments given in this specification.

Without intent to limit the scope of the disclosure, examples of instruments, apparatus, methods, and their related results according to the embodiments of the present disclosure are given below. Note that titles or subtitles may be used in the examples for the convenience of a reader, which in no way should limit the scope of the disclosure. Unless otherwise defined, technical and scientific terms used herein have the meaning as commonly understood by one of ordinary skill in the art to which this disclosure pertains. In the case of conflict, the present document, including definitions will control.

Additional features and advantages of the disclosure will be set forth in the description which follows, and in part will be obvious from the description, or can be learned by practice of the herein disclosed principles. The features and advantages of the disclosure can be realized and obtained by means of the instruments and combinations particularly pointed out in the appended claims. These and other features of the disclosure will become more fully apparent from the following description and appended claims or can be learned by the practice of the principles set forth herein.

AVs utilize many sensors such as a lidar sensor to navigate. Some lidar systems may include a lens or any suitable device to shape or direct laser illumination to produce an illumination pattern with more radiance towards a particular area. For example, the particular area may be the top of an elevation axis within the field of view (FOV) so that the quantity of projected laser illumination can be greater for objects that are farther away and such objects can be better detected. In another example, the particular area may be the bottom of the elevation axis within the FOV so that the quantity of projected laser illumination can be greater for objects that are located closer to the bottom of the perimeter of the vehicle so that such objects can be better detected.

It is crucial, especially in AV technologies to have a lidar system on vehicles that meets acceptable performance standards as accuracy, consistency, and reliability of sensor data are paramount to the AVs' safe and predictable operation. As such, the illumination assembly portion of the lidar system (e.g., the laser-based light source and lens) needs to be validated to ensure the quality and accuracy of the lidar system.

Accordingly, aspects of the present technology address the limitations of conventional lidar validation systems by providing solutions in which the lidar system can be validated based on an asymmetric illumination profile. More specifically, the present technology can provide an ideal asymmetric illumination profile to validate a lidar system.

Various examples of the subject technology are discussed with respect to lidar systems used in vehicles for illustrative purposes. Other examples may relate to other types and uses of lidar systems. These examples may be used in various fields and for various purposes.

### DESCRIPTION

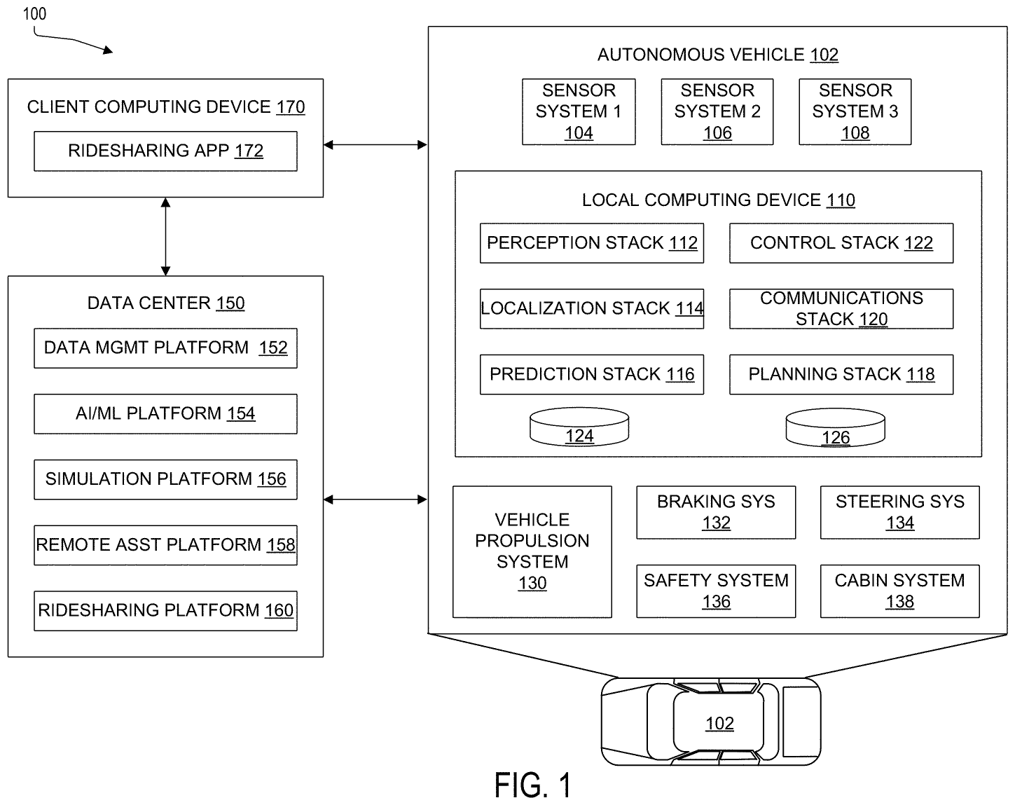

FIG. 1 illustrates art example of an AV management system 100. One of ordinary skill in the art will understand that, for the AV management system 100 and any system discussed in the present disclosure, there cart be additional or fewer components in similar or alternative configurations. The illustrations and examples provided in the present disclosure are for conciseness and clarity. Other embodiments may include different numbers and/or types of elements, but one of ordinary skill the art will appreciate that such variations do not depart from the scope of the present disclosure.

In this example, the AV management system 100 includes an AV 102, a data center 150, and a client computing device 170. The AV 102, the data center 150, and the client computing device 170 can communicate with one another over one or more networks (not shown), such as a public network (e.g., the Internet, art Infrastructure as a Service (IaaS) network, a Platform as a Service (PaaS) network, a Software as a Service (SaaS) network, other Cloud Service Provider (CSP) network, etc.), a private network (e.g., a Local Area Network (LAN), a private cloud, a Virtual Private Network (VPN), etc.), and/or a hybrid network (e.g., a multi-cloud or hybrid cloud network, etc.).

The AV 102 cart navigate roadways without a human driver based on sensor signals generated by multiple sensor systems 104, 106, and 108. The sensor systems 104-108 can include different types of sensors and cart be arranged about the AV 102. For instance, the sensor systems 104-108 can comprise Inertial Measurement Units (IMUs), cameras (e.g., still image cameras, video cameras, etc.), light sensors (e.g., LIDAR systems, ambient light sensors, infrared sensors, etc.), RADAR systems, GPS receivers, audio sensors (e.g., microphones, Sound Navigation and Ranging (SONAR) systems, ultrasonic sensors, etc.), engine sensors, speedometers, tachometers, odometers, altimeters, tilt sensors, impact sensors, airbag sensors, seat occupancy sensors, open/closed door sensors, tire pressure sensors, rain sensors, and so forth. For example, the sensor system 104 can be a camera system, the sensor system 106 cart be a LIDAR system, and the sensor system 108 can be a RADAR system. Other embodiments may include any other number and type of sensors.

The AV 102 can also include several mechanical systems that can be used to maneuver or operate the AV 102. For instance, the mechanical systems can include a vehicle propulsion system 130, a braking system 132, a steering system 134, a safety system 136, and a cabin system 138, among other systems. The vehicle propulsion system 130 can include an electric motor, an internal combustion engine, or both. The braking system 132 cart include an engine brake, brake pads, actuators, and/or any other suitable componentry configured to assist in decelerating the AV 102. The steering system 134 can include suitable componentry configured to control the direction of movement of the AV 102 during navigation. The safety system 136 cart include lights and signal indicators, a parking brake, airbags, and so forth. The cabin system 138 can include cabin temperature control systems, in-cabin entertainment systems, and so forth. In some embodiments, the AV 102 might not include human driver actuators (e.g., steering wheel, handbrake, foot brake pedal, foot accelerator pedal, turn signal lever, window wipers, etc.) for controlling the AV 102. Instead, the cabin system 138 can include one or more client interfaces (e.g., Graphical User Interfaces (GUIs), Voice User Interfaces (VUIs), etc.) for controlling certain aspects of the mechanical systems 130-138.

The AV 102 can additionally include a local computing device 110 that is in communication with the sensor systems 104-108, the mechanical systems 130-138, the data center 150, and the client computing device 170, among other systems. The local computing device 110 can include one or more processors and memory, including instructions that can be executed by the one or more processors. The instructions can make up one or more software stacks or components responsible for controlling the AV 102; communicating with the data center 150, the client computing device 170, and other systems; receiving inputs from riders, passengers, and other entities within the AV's environment; logging metrics collected by the sensor systems 104-108; and so forth. In this example, the local computing device 110 includes a perception stack 112, a mapping and localization stack 114, a prediction stack 116, a planning stack 118, a communications stack 120, a control stack 122, art AV operational database 124, and an HD geospatial database 126, among other stacks and systems.

The perception stack 112 can enable the AV 102 to “see” (e.g., via cameras, LIDAR sensors, infrared sensors, etc.), “hear” (e.g., via microphones, ultrasonic sensors, RADAR, etc.), and “feel” (e.g., pressure sensors, force sensors, impact sensors, etc.) its environment using information from the sensor systems 104-108, the mapping and localization stack 114, the HD geospatial database 126, other components of the AV, and other data sources (e.g., the data center 150, the client computing device 170, third party data sources, etc.). The perception stack 112 can detect and classify objects and determine their current locations, speeds, directions, and the like. In addition, the perception stack 112 can determine the free space around the AV 102 (e.g., to maintain a safe distance from other objects, change lanes, park the AV, etc.). The perception stack 112 can also identify environmental uncertainties, such as where to look for moving objects, flag areas that may be obscured or blocked from view, and so forth. In some embodiments, an output of the prediction stack can be a bounding area around a perceived object that can be associated with a semantic label that identifies the type of object that is within the bounding area, the kinematic of the object (information about its movement), a tracked path of the object, and a description of the pose of the object (its orientation or heading, etc.).

The mapping and localization stack 114 can determine the AV's position and orientation (pose) using different methods from multiple systems (e.g., GPS, IMUs, cameras, LIDAR, RADAR, ultrasonic sensors, the HD geospatial database 126, etc.). For example, in some embodiments, the AV 102 can compare sensor data captured in real-time by the sensor systems 104-108 to data in the HD geospatial database 126 to determine its precise (e.g., accurate to the order of a few centimeters or less) position and orientation. The AV 102 can focus its search based on sensor data from one or more first sensor systems (e.g., GPS) by matching sensor data from one or more second sensor systems (e.g., LIDAR). If the mapping and localization information from one system is unavailable, the AV 102 can use mapping and localization information from a redundant system and/or from remote data sources.

The prediction stack 116 can receive information from the localization stack 114 and objects identified by the perception stack 112 and predict a future path for the objects. In some embodiments, the prediction stack 116 can output several likely paths that art object is predicted to take along with a probability associated with each path. For each predicted path, the prediction stack 116 can also output a range of points along the path corresponding to a predicted location of the object along the path at future time intervals along with an expected error value for each of the points that indicates a probabilistic deviation from that point.

The planning stack 118 can determine how to maneuver or operate the AV 102 safely and efficiently in its environment. For example, the planning stack 118 can receive the location, speed, and direction of the AV 102, geospatial data, data regarding objects sharing the road with the AV 102 (e.g., pedestrians, bicycles, vehicles, ambulances, buses, cable cars, trains, traffic lights, lanes, road markings, etc.) or certain events occurring during a trip (e.g., emergency vehicle blaring a siren, intersections, occluded areas, street closures for construction or street repairs, double-parked cars, etc.), traffic rules and other safety standards or practices for the road, user input, and other relevant data for directing the AV 102 from one point to another and outputs from the perception stack 112, localization stack 114, and prediction stack 116. The planning stack 118 can determine multiple sets of one or more mechanical operations that the AV 102 can perform (e.g., go straight at a specified rate of acceleration, including maintaining the same speed or decelerating; turn on the left blinker, decelerate if the AV is above a threshold range for turning, and turn left; turn on the right blinker, accelerate if the AV is stopped or below the threshold range for turning, and turn right; decelerate until completely stopped and reverse; etc.), and select the best one to meet changing road conditions and events. If something unexpected happens, the planning stack 118 can select from multiple backup plans to carry out. For example, while preparing to change lanes to turn right at an intersection, another vehicle may aggressively cut into the destination lane, making the lane change unsafe. The planning stack 118 could have already determined an alternative plan for such an event. Upon its occurrence, it could help direct the AV 102 to go around the block instead of blocking a current lane while waiting for an opening to change lanes.

The control stack 122 can manage the operation of the vehicle propulsion system 130, the braking system 132, the steering system 134, the safety system 136, and the cabin system 138. The control stack 122 can receive sensor signals from the sensor systems 104-108 as well as communicate with other stacks or components of the local computing device 110 or a remote system (e.g., the data center 150) to effectuate operation of the AV 102. For example, the control stack 122 can implement the final path or actions from the multiple paths or actions provided by the planning stack 118. This can involve turning the routes and decisions from the planning stack 118 into commands for the actuators that control the AV's steering, throttle, brake, and drive unit.

The communications stack 120 can transmit and receive signals between the various stacks and other components of the AV 102 and between the AV 102, the data center 150, the client computing device 170, and other remote systems. The communications stack 120 can enable the local computing device 110 to exchange information remotely over a network, such as through an antenna array or interface that can provide a metropolitan WIFI network connection, a mobile or cellular network connection (e.g., Third Generation (3G), Fourth Generation (4G), Long-Term Evolution (LTE), 5th Generation (5G), etc.), and/or other wireless network connection (e.g., License Assisted Access (LAA), Citizens Broadband Radio Service (CBRS), MULTEFIRE, etc.). The communications stack 120 can also facilitate the local exchange of information, such as through a wired connection (e.g., a user's mobile computing device docked in an in-car docking station or connected via Universal Serial Bus (USB), etc.) or a local wireless connection (e.g., Wireless Local Area Network (WLAN), Bluetooth®, infrared, etc.).

The HD geospatial database 126 can store HD maps and related data of the streets upon which the AV 102 travels. In some embodiments, the HD maps and related data can comprise multiple layers, such as an areas layer, a lanes and boundaries layer, an intersections layer, a traffic controls layer, and so forth. The areas layer can include geospatial information indicating geographic areas that are drivable (e.g., roads, parking areas, shoulders, etc.) or not drivable (e.g., medians, sidewalks, buildings, etc.), drivable areas that constitute links or connections (e.g., drivable areas that form the same road) versus intersections (e.g., drivable areas where two or more roads intersect), and so on. The lanes and boundaries layer can include geospatial information of road lanes (e.g., lane centerline, lane boundaries, type of lane boundaries, etc.) and related attributes (e.g., direction of travel, speed limit, lane type, etc.). The lanes and boundaries layer can also include 3D attributes related to lanes (e.g., slope, elevation, curvature, etc.). The intersections layer can include geospatial information of intersections (e.g., crosswalks, stop lines, turning lane centerlines and/or boundaries, etc.) and related attributes (e.g., permissive, protected/permissive, or protected only left turn lanes; legal or illegal u-turn lanes; permissive or protected only right turn lanes; etc.). The traffic controls lane can include geospatial information of traffic signal lights, traffic signs, and other road objects and related attributes.

The AV operational database 124 can store raw AV data generated by the sensor systems 104-108, stacks 112-122, and other components of the AV 102 and/or data received by the AV 102 from remote systems (e.g., the data center 150, the client computing device 170, etc.). In some embodiments, the raw AV data can include HD LIDAR point cloud data, image data, RADAR data, GPS data, and other sensor data that the data center 150 can use for creating or updating AV geospatial data or for creating simulations of situations encountered by AV 102 for future testing or training of various machine learning algorithms that are incorporated in the local computing device 110.

The data center 150 can be a private cloud (e.g., an enterprise network, a co-location provider network, etc.), a public cloud (e.g., an Infrastructure as a Service (IaaS) network, a Platform as a Service (PaaS) network, a Software as a Service (SaaS) network, or other Cloud Service Provider (CSP) network), a hybrid cloud, a multi-cloud, and so forth. The data center 150 can include one or more computing devices remote to the local computing device 110 for managing a fleet of AVs and AV-related services. For example, in addition to managing the AV 102, the data center 150 may also support a ridesharing service, a delivery service, a remote/roadside assistance service, street services (e.g., street mapping, street patrol, street cleaning, street metering, parking reservation, etc.), and the like.

The data center 150 can send and receive various signals to and from the AV 102 and the client computing device 170. These signals can include sensor data captured by the sensor systems 104-108, roadside assistance requests, software updates, ridesharing pick-up and drop-off instructions, and so forth. In this example, the data center 150 includes a data management platform 152, an Artificial Intelligence/Machine Learning (AI/ML) platform 154, a simulation platform 156, a remote assistance platform 158, and a ridesharing platform 160, among other systems.

The data management platform 152 can be a “big data” system capable of receiving and transmitting data at high velocities (e.g., near real-time or real-time), processing a large variety of data and storing large volumes of data (e.g., terabytes, petabytes, or more of data). The varieties of data can include data having different structured (e.g., structured, semi-structured, unstructured, etc.), data of different types (e.g., sensor data, mechanical system data, ridesharing service, map data, audio, video, etc.), data associated with different types of data stores (e.g., relational databases, key-value stores, document databases, graph databases, column-family databases, data analytic stores, search engine databases, time series databases, object stores, file systems, etc.), data originating from different sources (e.g., AVs, enterprise systems, social networks, etc.), data having different rates of change (e.g., batch, streaming, etc.), or data having other heterogeneous characteristics. The various platforms and systems of the data center 150 can access data stored by the data management platform 152 to provide their respective services.

The AI/ML platform 154 can provide the infrastructure for training and evaluating machine learning algorithms for operating the AV 102, the simulation platform 156, the remote assistance platform 158, the ridesharing platform 160, and other platforms and systems. Using the AI/ML platform 154, data scientists can prepare data sets from the data management platform 152; select, design, and train machine learning models; evaluate, refine, and deploy the models; maintain, monitor, and retrain the models; and so on.

The simulation platform 156 can enable testing and validation of the algorithms, machine learning models, neural networks, and other development efforts for the AV 102, the remote assistance platform 158, the ridesharing platform 160, and other platforms and systems. The simulation platform 156 can replicate a variety of driving environments and/or reproduce real-world scenarios from data captured by the AV 102, including rendering geospatial information and road infrastructure (e.g., streets, lanes, crosswalks, traffic lights, stop signs, etc.) obtained from a cartography platform; modeling the behavior of other vehicles, bicycles, pedestrians, and other dynamic elements; simulating inclement weather conditions, different traffic scenarios; and so on.

The remote assistance platform 158 can generate and transmit instructions regarding the operation of the AV 102. For example, in response to an output of the AI/ML platform 154 or other system of the data center 150, the remote assistance platform 158 can prepare instructions for one or more stacks or other components of the AV 102.

The ridesharing platform 160 can interact with a customer of a ridesharing service via a ridesharing application 172 executing on the client computing device 170. The client computing device 170 can be any type of computing system, including a server, desktop computer, laptop, tablet, smartphone, smart wearable device (e.g., smartwatch, smart eyeglasses or other Head-Mounted Display (HMD), smart ear pods, or other smart in-ear, on-ear, or over-ear device, etc.), gaming system, or other general-purpose computing device for accessing the ridesharing application 172. The client computing device 170 can be a customer's mobile computing device or a computing device integrated with the AV 102 (e.g., the local computing device 110). The ridesharing platform 160 can receive requests to pick up or drop off from the ridesharing application 172 and dispatch the AV 102 for the trip.

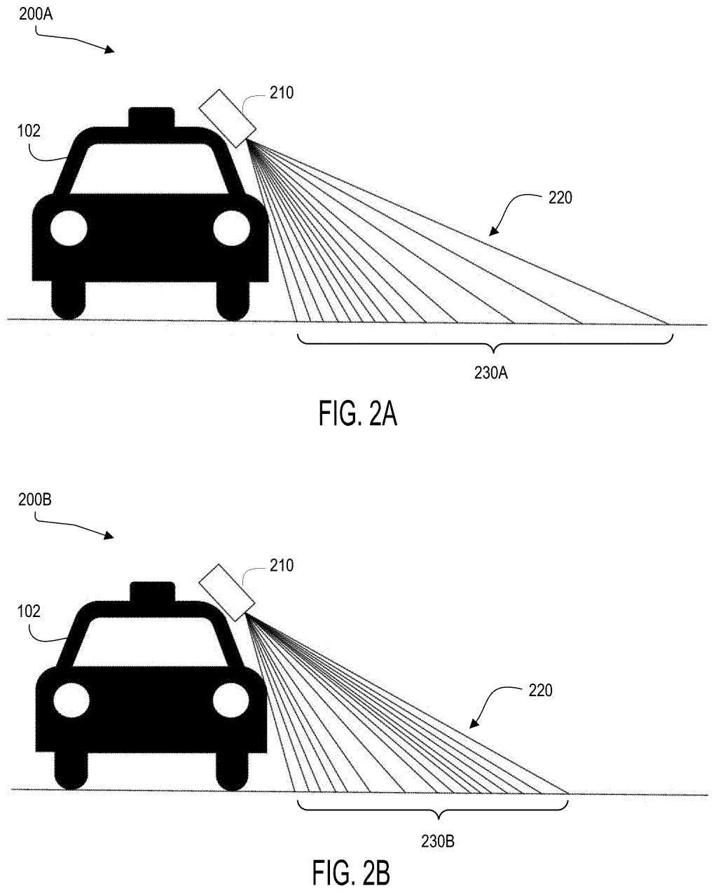

FIGS. 2A and 2B illustrate an example environment for a lidar system 200A and 200B. Example environments 200A and 200B have a lidar system 210 disposed on a vehicle 102 (e.g., art AV) and configured to scan a field of view (FOV) 230A and 230B, respectively. In some embodiments, lidar system 210 can be a sparse lidar system.

According to some examples, lidar system, 210 can be positioned near a roofline of vehicle 102 and pointed down towards the ground to detect objects in close proximity to vehicle 102. For example, lidar system 210 projects laser illumination 220 with intensity towards the ground, which can be defined by an illumination pattern. The illumination pattern can provide a map of the intensity of laser illumination 220 across the entire FOVs 230A and 230B of lidar system 210.

In some examples, lidar system 210 can comprise a laser-based light source (i.e., transmitter, a receiver, and a lens. According to some examples, the laser-based light source emits the light (e.g., laser illumination 220) towards a target and illuminates the location of objects within the target, which can be determined based upon reflected light. In some instances, the reflected light can be detected by the receiver.

In some examples, the laser-based light source of lidar system 210 can be a vertical-cavity surface-emitting laser (VCSEL) or any applicable laser device that emits light with sufficient intensity. In some examples, the receiver of lidar system 210 can be configured to detect the reflected light, which can provide an illumination pattern that represents the distribution of the light intensity across FOV 230A or 230B.

According to some examples, lidar system, 210 can further include a lens, which can be configured to redirect laser illumination from the laser-based light source to one or more parts of FOV 230A or 230B and to form the desired illumination pattern. More specifically, the lens can be placed adjacent to the laser-based light source to diffuse laser illumination 220, thereby increasing FOV 230A or 230B to the desired level. In some examples, the lens can be an aspheric lens or a free-form lens in a non-spherical shape.

In FIG. 2A, the lens of lidar system 210 is positioned in a way that the bottom of FOV 230A is smaller than the top of FOV 230A on a road surface, and therefore, laser illumination 220 is more concentrated on the ground that is closer to vehicle 102 (e.g., 0-6 feet from vehicle 102). On the other hand, in FIG. 2B, the lens of lidar system 210 is angled in a way that the top of FOV 230B is smaller than the bottom of FOV 230B and therefore, laser illumination 220 is more concentrated on the ground that is farther from vehicle 102 (e.g., 6-20 feet from vehicle 102). Accordingly, by selectively directing proportions of laser illumination to different parts of the FOV (i.e., by adjusting the positioning of the lens), lidar system 210 can be used to direct laser illumination to any desired parts of the FOV.

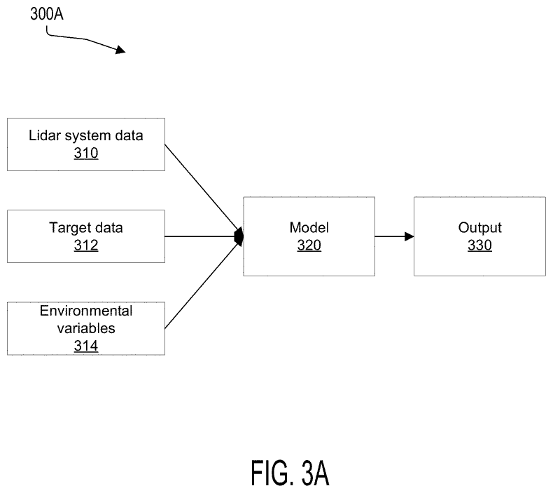

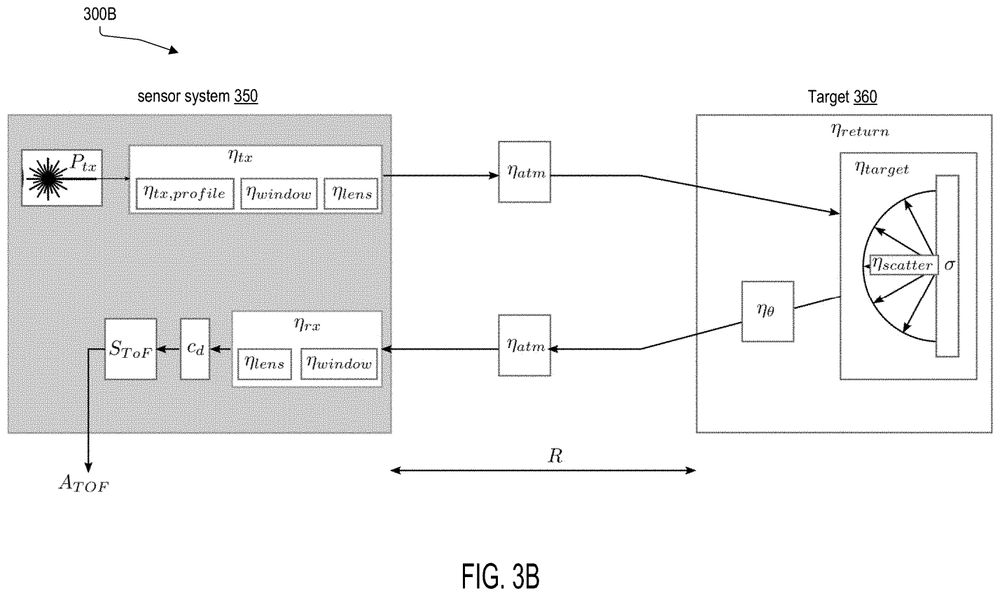

FIG. 3A illustrates an example diagram for a lidar validation system 300A. Lidar validation system 300A can include but is not limited to lidar system data 310, target data 312, environmental variables 314, model 320, and output 330.

In some examples, lidar system data 310 include a radiant intensity, a diffuse angle (i.e., a full angular spread of the illumination profile), a wavelength of the laser illumination emitted by the laser-based light source, an illumination ratio, a number of the laser-based light source of the lidar system, or any features or characteristics associated with the configuration of the lidar system.

In some examples, the illumination ratio is greater than 1. but at one point we used an “illumination ratio” as part of the photon budget that served as a fill-factor. The “illumination ratio” was just the ratio of the angular spread of the illumination, compared with the angular Field of View of the LiDAR across an axis (for example, Horizontal). If the “illumination ratio” was greater than 1, then there was enough angular spread of the illumination to cover the entire FOV.

In some instances, target data 312 represent a target area within the field of view. For example, target data 312 can provide the desired portion on the ground where the lidar system is to detect, for example, closer to the vehicle as shown in FIG. 2A or farther from the vehicle as shown in FIG. 2B.

In some examples, environmental variables 314 include a factor or variable that may affect how the illumination is projected. Examples of environmental variables 314 can include but are not limited to an amount of ambient light, a reflectivity, an atmospheric extinction, or a temperature.

In some instances, a photon budget of the lidar system can be calculated based on lidar system data 310 and environmental variables 314 as input. The output can provide the concentration of illumination that would be required to detect an object(s) at a given distance from the lidar.

In some examples, target data 312 can be determined based on the mounting geometry of the lidar system on the vehicle. The output (e.g., target data 312) can provide which parts of the FOV of the lidar system are required to detect an object(s) at a given distance from the lidar.

According to some examples, such outputs (e.g., the concentration of illumination that is required and/or which parts of the FOV of the lidar system are required) can be combined to calculate the ideal illumination profile over the entire FOV of the lidar system.

In some examples, lidar system data 310, target data 312, and environmental variables 314 can be stored in AV operational database 124 as illustrated in FIG. 1, and later provided to data center 150.

According to some examples, model 320 can determine an amount of light across the FOV based on lidar system data 310, target data 312, and/or environmental variables 314. For example, model 320 can determine art amount of photons emitted by the laser-based light source of the lidar system and art amount of photons then received by the receiver of the lidar system to determine the amount of light across the FOV.

Based on the amount of light across the FOV determined by model 320, the lidar validation system 300A can generate an ideal illumination profile as output 330, which can be used to validate the lidar system.

FIG. 3B illustrates another example diagram for a lidar validation system 300B. As shown in FIG. 3B, lidar validation system 300B can include sensor system 350 and target 360 (i.e., object being detected by sensor system 350). In FIG. 3B, each block represents a component or loss factor of the model for lidar validation system 300B.

According to some examples, the output optical power, in sensor system 350, can be represtedn by variable Pₜₓ. Also, ηₜₓ describes the optical elements in the transmission path. The asymmetric illumination profile is created based on η_{tx,profile}. In the return path, ηₙₓ describes loss variables from the return optical elements. Loss and conversion factors from the image sensor are represented in variables c_{d} and S_{ToF} and are specific to the image sensor.

In some instances, environmental losses between sensor system 350 and target 360 at distance R can be represented by variable ηₐₜₘ. The scattering properties of target 360 can be repsented by variables η_{scatter} and σ.

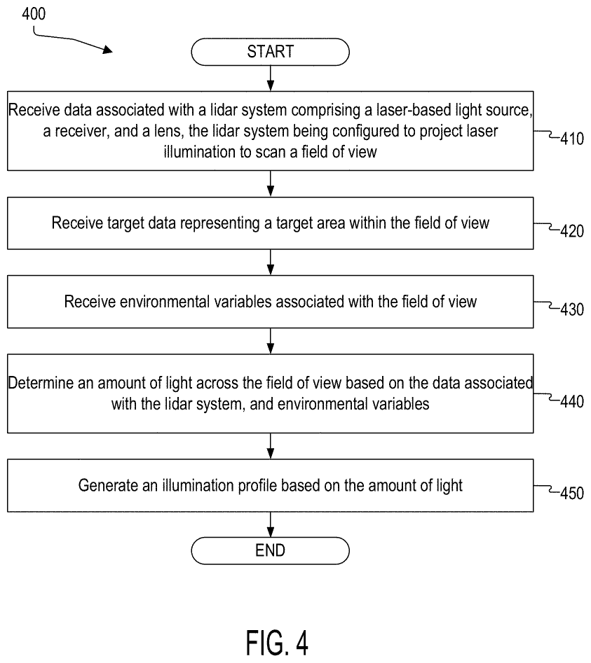

FIG. 4 is a flowchart of art example method 400 for validating a lidar system based on an illumination profile according to some aspects of the disclosed technology. Although example method 400 depicts a particular sequence of operations, the sequence may be altered without departing from the scope of the present disclosure. For example, some of the operations depicted may be performed in parallel or in a different sequence that does not materially affect the function of method 400. In other examples, different components of art example device or system that implements the method 400 may perform functions at substantially the same time or in a specific sequence.

According to some examples, method 400 includes receiving data associated with a lidar system at step 410. In some instances, the lidar system comprises a laser-based light source, a receiver, and a lens and can be configured to project laser illumination to scan a field of view (FOV). For example, lidar validation system 300A as illustrated in FIG. 3A may receive lidar system data 310 associated with lidar system 210 illustrated in FIGS. 2A and 2B, which comprises a laser-based light source (e.g., VCSEL), a receiver, and a lens. In some examples, lidar system 210 as illustrated in FIGS. 2A and 2B is configured to project laser illumination to scan FOV 230A or 230B. As previously described, the data associated with a lidar system can include a radiant intensity, a diffuse angle, a wavelength of the laser illumination emitted by the laser-based light source, art illumination ratio, or a number of the laser-based light source of the lidar system.

According to some examples, method 400 includes receiving target data representing a target area within the field of view at step 420. For example, lidar validation system 300A as illustrated in FIG. 3A may receive target data 312 that indicate a target area within the field of view that lidar system 210 is to project laser illumination 220.

According to some examples, method 400 includes receiving environmental variables associated with the FOV at step 430. For example, lidar validation system 300A as illustrated in FIG. 3A may receive environmental variables 314, which can include at least one of an amount of ambient light, a reflectivity, an atmospheric extinction, or temperature.

According to some examples, method 400 includes determining an amount of light across the FOV based on the data associated with the lidar system, the target data, and the environmental variables at step 440. For example, lidar validation system 300A as illustrated in FIG. 3A may determine an amount of light across FOV based on lidar system data 310, target data 312, and environmental variables 314 based on model 320.

As previously described, lidar validation system 300A as illustrated in FIG. 3A may receive lidar system data 310 and environmental variables 314 as input and calculate a photon budget of the lidar system. As such, lidar validation system 300A can determine the concentration of illumination that would be required to detect an object(s) at a given distance from the lidar.

Further, lidar validation system 300A as illustrated in FIG. 3A may determine target data 312 based on the mounting geometry of the lidar system on the vehicle. Accordingly, lidar validation system 300A may determine, based on target data 312, which parts of the FOV of the lidar system are required to detect an object(s) at a given distance from the lidar.

Based on one or a combination of lidar system data 310, environmental variables 314, and target data 312 including the concentration of illumination that is required and which parts of the FOV of the lidar system are required to detect an object(s) at a given distance from the lidar, lidar validation system 300A as illustrated in FIG. 3A can calculate the ideal illumination profile over the entire FOV of the lidar system.

According to some examples, method 400 includes generating an illumination profile based on the amount of light at step 450. For example, lidar validation system 300A as illustrated in FIG. 3A may generate an illumination profile based on the amount of light from step 440. The illumination profile can be an indicator of an optimal distribution of the light of the lidar system and be used to validate a lidar system of interest.

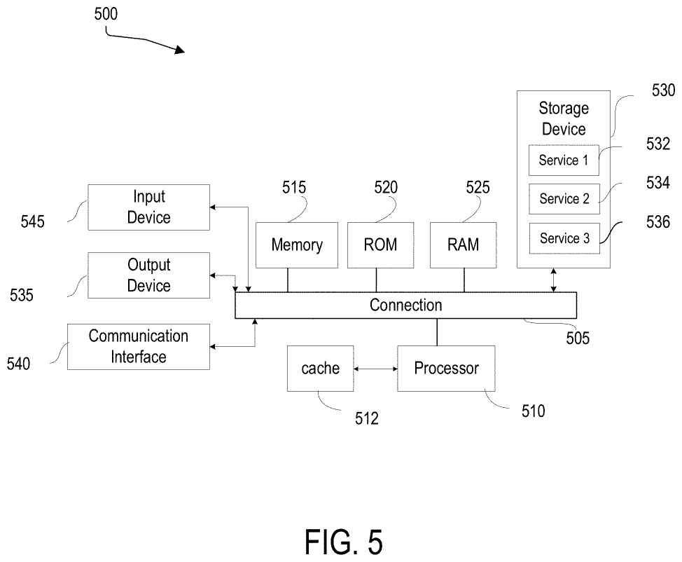

FIG. 5 shows an example of computing system 500, which can be for example any computing device making up computing system 410 as illustrated in FIG. 4, or any component thereof in which the components of the system are in communication with each other using connection 505. Connection 505 can be a physical connection via a bus, or a direct connection into processor 510, such as in a chipset architecture. Connection 505 can also be a virtual connection, networked connection, or logical connection.

In some embodiments, computing system 500 is a distributed system in which the functions described in this disclosure cart be distributed within a data center, multiple data centers, a peer network, etc. In some embodiments, one or more of the described system components represents many such components each performing some or all of the function for which the component is described. In some embodiments, the components cart be physical or virtual devices.

Example system 500 includes at least one processing unit (CPU or processor) 510 and connection 505 that couples various system components including system memory 515, such as read-only memory (ROM) 520 and random-access memory (RAM) 525 to processor 510. Computing system 500 can include a cache of high-speed memory 512 connected directly with, in close proximity to, or integrated as part of processor 510.

Processor 510 cart include any general-purpose processor and a hardware service or software service, such as services 532, 534, and 536 stored in storage device 530, configured to control processor 510 as well as a special-purpose processor where software instructions are incorporated into the actual processor design. Processor 510 may essentially be a completely self-contained computing system, containing multiple cores or processors, a bus, memory controller, cache, etc. A multi-core processor may be symmetric or asymmetric.

To enable user interaction, computing system 500 includes an input device 545, which can represent any number of input mechanisms, such as a microphone for speech, a touch-sensitive screen for gesture or graphical input, keyboard, mouse, motion input, speech, etc. Computing system 500 can also include output device 535, which can be one or more of a number of output mechanisms known to those of skill in the art. In some instances, multimodal systems can enable a user to provide multiple types of input/output to communicate with computing system 500. Computing system 500 can include communications interface 540, which cart generally govern and manage the user input and system output. There is no restriction on operating on any particular hardware arrangement, and therefore the basic features here may easily be substituted for improved hardware or firmware arrangements as they are developed.

Storage device 530 can be a non-volatile memory device and can be a hard disk or other types of computer readable media which can store data that are accessible by a computer, such as magnetic cassettes, flash memory cards, solid state memory devices, digital versatile disks, cartridges, random access memories (RAMs), read-only memory (ROM), and/or some combination of these devices.

The storage device 530 can include software services, servers, services, etc., that when the code that defines such software is executed by the processor 510, it causes the system to perform a function. In some embodiments, a hardware service that performs a particular function can include the software component stored in a computer-readable medium in connection with the necessary hardware components, such as processor 510, connection 505, output device 535, etc., to carry out the function.

For clarity of explanation, in some instances the present technology may be presented as including individual functional blocks including functional blocks comprising devices, device components, steps or routines in a method embodied in software, or combinations of hardware and software.

Any of the steps, operations, functions, or processes described herein may be performed or implemented by a combination of hardware and software services or services, alone or in combination with other devices. In some embodiments, a service can be software that resides in memory of a client device and/or one or more servers of a content management system and perform one or more functions when a processor executes the software associated with the service. In some embodiments, a service is a program, or a collection of programs that carry out a specific function. In some embodiments, a service can be considered a server. The memory can be a non-transitory computer-readable medium.

In some embodiments the computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per se.

Methods according to the above-described examples can be implemented using computer-executable instructions that are stored or otherwise available from computer readable media. Such instructions can comprise, for example, instructions and data which cause or otherwise configure a general purpose computer, special purpose computer, or special purpose processing device to perform a certain function or group of functions. Portions of computer resources used can be accessible over a network. The computer executable instructions may be, for example, binaries, intermediate format instructions such as assembly language, firmware, or source code. Examples of computer-readable media that may be used to store instructions, information used, and/or information created during methods according to described examples include magnetic or optical disks, solid state memory devices, flash memory, USB devices provided with non-volatile memory, networked storage devices, and so on.

Devices implementing methods according to these disclosures can comprise hardware, firmware and/or software, and can take any of a variety of form factors. Typical examples of such form factors include servers, laptops, smart phones, small form factor personal computers, personal digital assistants, and so on. Functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are means for providing the functions described in these disclosures.

Although a variety of examples and other information was used to explain aspects within the scope of the appended claims, no limitation of the claims should be implied based on particular features or arrangements in such examples, as one of ordinary skill would be able to use these examples to derive a wide variety of implementations. Further and although some subject matter may have been described in language specific to examples of structural features and/or method steps, it is to be understood that the subject matter defined in the appended claims is not necessarily limited to these described features or acts. For example, such functionality can be distributed differently or performed in components other than those identified herein. Rather, the described features and steps are disclosed as examples of components of systems and methods within the scope of the appended claims.

Claim language or other language reciting “at least one of” a set and/or “one or more” of a set indicates that one member of the set or multiple members of the set (in any combination) satisfy the claim. For example, claim language reciting “at least one of A and B” or “at least one of A or B” means A, B, or A and B. In another example, claim language reciting “at least one of A, B, and C” or “at least one of A, B, or C” means A, B, C, or A and B, or A and C, or B and C, or A and B and C. The language “at least one of” a set and/or “one or more” of a set does not limit the set to the items listed in the set. For example, claim language reciting “at least one of A and B” or “at least one of A or B” can mean A, B, or A and B, and can additionally include items not listed in the set of A and B.

What is claimed is:

1. A system comprising:
one or more processors; and
a computer-readable medium comprising instructions stored therein, which when executed by the one or more processors, cause the one or more processors to:
receive data associated with a Light Detection and Ranging (lidar) system comprising a laser-based light source, a receiver, and a lens, the lidar system being configured to project laser illumination to scan a field of view;
receive target data representing a target area within the field of view;
receive environmental variables associated with the field of view;
determine an amount of light across the field of view based on the data associated with the lidar system, the target data, and the environmental variables; and
generate art illumination profile based on the amount of light.

2. The system of claim 1, wherein the determining the amount of light across the field of view includes:
determining art amount of photons emitted by the laser-based light source to each portion of the field of view; and
determining an amount of photons received by the receiver of the lidar system for each portion of the field of view.

3. The system of claim 1, wherein the data associated with the lidar system include at least one of a radiant intensity, a diffuser angle, a wavelength of the laser illumination emitted by the laser-based light source, an illumination ratio, or a number of the laser-based light source.

4. The system of claim 3, wherein the illumination ratio is greater than 1.

5. The system of claim 1, wherein the environmental variables associated with the field of view include at least one of an amount of ambient light, a reflectivity, an atmospheric extinction, or temperature.

6. The system of claim 1, wherein the laser-based light source is a vertical-cavity surface-emitting laser (VCSEL).

7. The system of claim 1, wherein the lens is configured to redirect laser illumination from the laser-based light source.

8. A method comprising:
receiving data associated with a lidar system comprising a laser-based light source, a receiver, and a lens, the lidar system being configured to project laser illumination to scan a field of view;
receiving target data representing a target area within the field of view;
receiving environmental variables associated with the field of view;
determining art amount of light across the field of view based on the data associated with the lidar system, the target data, and the environmental variables; and
generating an illumination profile based on the amount of light.

9. The method of claim 8, wherein the determining the amount of light across the field of view includes:
determining art amount of photons emitted by the laser-based light source to each portion of the field of view; and
determining an amount of photons received by the receiver of the lidar system for each portion of the field of view.

10. The method of claim 8, wherein the data associated with the lidar system include at least one of a radiant intensity, a diffuser angle, a wavelength of the laser illumination emitted by the laser-based light source, an illumination ratio, or a number of the laser-based light source.

11. The method of claim 10, wherein the illumination ratio is greater than 1.

12. The method of claim 8, wherein the environmental variables associated with the field of view include at least one of an amount of ambient light, a reflectivity, an atmospheric extinction, or temperature.

13. The method of claim 8, wherein the laser-based light source is a vertical-cavity surface-emitting laser (VCSEL).

14. The method of claim 8, wherein the lens is configured to redirect laser illumination from the laser-based light source.

15. A non-transitory computer-readable storage medium comprising computer-readable instructions, which when executed by a computing system, cause the computing system to:
receive data associated with a lidar system comprising a laser-based light source, a receiver, and a lens, the lidar system being configured to project laser illumination to scan a field of view;
receive target data representing a target area within the field of view;
receive environmental variables associated with the field of view;
determine art amount of light across the field of view based on the data associated with the lidar system, the target data, and the environmental variables; and
generate art illumination profile based on the amount of light.

16. The non-transitory computer-readable storage medium of claim 15, wherein the determining the amount of light across the field of view includes:
determining art amount of photons emitted by the laser-based light source to each portion of the field of view; and
determining an amount of photons received by the receiver of the lidar system for each portion of the field of view.

17. The non-transitory computer-readable storage medium of claim 15, wherein the data associated with the lidar system include at least one of a radiant intensity, a diffuser angle, a wavelength of the laser illumination emitted by the laser-based light source, an illumination ratio, or a number of the laser-based light source.

18. The non-transitory computer-readable storage medium of claim 17, wherein the illumination ratio is greater than 1.

19. The non-transitory computer-readable storage medium of claim 15, wherein the environmental variables associated with the field of view include at least one of an amount of ambient light, a reflectivity, an atmospheric extinction, or temperature.

20. The non-transitory computer-readable storage medium of claim 15, wherein the laser-based light source is a vertical-cavity surface-emitting laser (VCSEL).
